(19) United States
(12) Patent Application Publication
(10) Pub. No.: US 2024/0200277 A1
(43) Pub. Date: Jun. 20, 2024

(54) METHOD FOR PRODUCING MOLDING AND/OR DRYING MODULES FOR THE PRODUCTION OF CONTAINERS COMPRISING FIBERS, METHOD AND DEVICE FOR PRODUCING A CONTAINER COMPRISING FIBERS USING A MOLDING AND/OR DRYING MODULE

(71) Applicant: Krones AG, Neutraubling (DE)

(72) Inventors: Jörg ZACHARIAS, Köfering (DE); Angelika GROSSER, Emmerting (DE); Robert AUMER, Woerth a. d. Donau (DE); Andreas HIPPEL, Woerth a. d. Donau (DE); Florian SCHINDLER, Regenstauf (DE)

(21) Appl. No.: 18/545,918

(22) Filed: Dec. 19, 2023

(30) Foreign Application Priority Data
Dec. 20, 2022 (DE) 102022134093.7

(51) Int. Cl. D21J 3/10; B33Y 10/00; B33Y 40/20; B33Y 80/00; D21F 13/00

(52) U.S. Cl. CPC D21J 3/10; B33Y 10/00; B33Y 40/20; B33Y 80/00; D21F 13/00

(57) ABSTRACT

The disclosure relates to a method for producing molding and/or drying modules for the production of containers comprising fibers by means of the molding and/or drying modules, wherein the method comprises producing a molding and/or drying module, wherein at least a part of the molding and/or drying module is produced by means of an additive manufacturing method, for example by means of 3D printing. The disclosure further relates to a device for carrying out the method for producing molding and/or drying modules for the production of containers comprising fibers, a molding and/or drying module produced by means of this method, a method for producing a container comprising fibers using a molding and/or drying module which has been produced by means of the method for producing molding and/or drying modules for the production of containers comprising fibers, and a device for producing containers comprising fibers.

### CROSS REFERENCE TO RELATED APPLICATION

The present application claims priority to German Patent Application No. 10 2022 134 093.7 filed on Dec. 20, 2022. The entire contents of the above-listed application are hereby incorporated by reference for all purposes.

### TECHNICAL FIELD

The disclosure relates to a method for producing molding and/or drying modules for the production of containers comprising fibers, to a device for carrying out the method, to a molding and/or drying module, to a method for producing a container comprising fibers using a molding and/or drying module, and to a device for producing containers comprising fibers using fiber-containing pulp, wherein the device comprises one or more molding and/or drying modules as described herein.

### BACKGROUND

WO 2016/055073 A1 discloses the use of a multipart mold for molding containers using pulp. For example, the mold can comprise two halves that have a first cavity for introducing the pulp and a second cavity for receiving and transferring water that has been squeezed out of the pulp to an exit. The multi-part mold can consist of polymer, ceramic or metal such as aluminum.

### SUMMARY

It can be difficult in terms of manufacturing to produce the somewhat complex-structured mold for molding containers using pulp by means of turning and milling parts or by deep drawing.

When there is a variation of the geometry of the container to be produced, this also means that the complex manufacturing process must be restarted to produce a mold suitable for the variation of the geometry.

### Object

The object of the disclosure is to provide a method for producing molding and/or drying modules for the production of containers comprising fibers, a device for carrying out the method, a molding and/or drying module, a method for producing a container comprising fibers using a molding and/or drying module, and a device for producing containers comprising fibers using fiber-containing pulp, wherein the device comprises one or more molding and/or drying modules, all of which offer improved functionality.

### Achievement

The object is achieved by the method for producing molding and/or drying modules for the production of containers comprising fibers, the device for carrying out the method, the molding and/or drying module, the method for producing a container comprising fibers using a molding and/or drying module, and the device for producing containers comprising fibers using fiber-containing pulp, wherein the device comprises one or more molding and/or drying modules. Further embodiments are disclosed herein.

The method according to the disclosure for producing molding and/or drying modules for the production of containers comprising fibers by means of the molding and/or drying modules comprises producing a molding and/or drying module, wherein at least part of the molding and/or drying module is produced by means of an additive manufacturing method, for example by means of 3D printing.

The additive manufacturing method may comprise a powder-based method, such as selective laser melting.

Any additive manufacturing method can be used as the additive manufacturing method.

A molding module can be used for molding a container comprising fibers. A drying module can be used for drying a/the molded container comprising fibers. There can be two modules.

It can also be provided that a single molding and/or drying module can be used in which a container comprising fibers can first be molded, and then (in the same module) the previously molded container comprising fibers can be dried.

The inner surface of the molding and/or drying module can correspond to or substantially correspond to an outer contour of a container comprising fibers that is to be produced. The container to be produced can be a bottle (with or without a thread), a can or the like.

An outer surface of the molding and/or drying module can comprise holding devices and/or eyelets. For example, an outer surface may have the same design for molding and/or drying modules that have different inner surfaces. One type of housing for different molding and/or drying modules can therefore be used. Using one type of housing may allow for technically simpler use since infrastructure does not need to be provided for different types of housings.

The molding and/or drying module, and/or an outer geometry of the molding and/or drying module, and/or a housing for the molding and/or drying module, and/or an outer geometry of the housing can be designed such that they can be similar to the functionality of the bottle molds of a PET blow molding machine.

The molding and/or drying module can comprise a support structure. Like the molding and/or drying module, the support structure can be produced by means of 3D printing. For example, the support structure can be arranged in a molding module in order to support drainage of the fiber-containing pulp introduced into the molding module. The support structure can comprise pores and/or passages and/or channels, or a matrix with pores and/or passages and/or channels. For example, the support structure can serve as a support for a screen on which introduced fiber-containing pulp can be deposited. A mesh width of the support structure can be provided in such a way that an optimal ratio can be adjustable between a fiber length and/or fiber length distribution of a fiber-containing pulp used for the production of a container comprising fibers and a pore size of the molding and/or drying module.

The fibers can comprise lignin, banana leaves and/or quinine. The fibers can comprise, for example, cellulose fibers, fibers from softwoods, broad-leaved woody plants, and/or sycamores, and/or from grasses, reeds, and/or bamboo, or the like. The fibers can comprise silk threads, spider threads, algae, natural fibers (such as cup-plant fibers, hemp, corn, cotton), banana peels, orange peels, grass, straw, potato starch, or processed cow manure. Also, cellulose fibers can be provided which originate from a process by which they were artificially grown. These alternative materials can completely or partially replace wood as the base material for a fluid mass with fibers when there are material shortages.

The fibers can comprise fiber mixtures made of non-wood material, for example cotton, hemp and/or textile fibers.

For example, the fibers can comprise viscose fibers. A viscose fiber is an artificial fiber made of regenerated cellulose, wherein the viscose fibers have, as starting base, 100% cellulose treated in a multi-stage process. The viscose fibers can comprise a flat or cable-like structure, a trilobal shape, or a double trilobal structure. The fibers can comprise a flat or hollow structure or a corrugated or rough outer surface.

Various types of fibers can also be used in combination. For example, fibers with different outer surfaces, and/or shapes, and/or a hollow structure, and/or a flat structure, and/or made of different materials can be combined. The fibers can be original, smooth, chopped, milled or fibrillated.

Due to the natural origin of the fibers, they can be biodegradable. In addition, they are sustainable and renewable.

The fibers may be used in a pulp. The pulp may be referred to as fiber-containing pulp. The pulp can be or comprise a mixture of water, for example with additives, and fibers. The pulp can be used, for example, for the production of the containers comprising fibers. The pulp can be introduced into the molding and/or drying module which was produced by means of 3D printing.

A metal or metal mixture, for example steel, stainless steel or aluminum, can be used for the 3D printing. When choosing the material used for the 3D printing, care can be taken to ensure that the molding and/or drying modules produced with and from it can achieve a predetermined strength and/or temperature resistance. In addition, metal or metal mixtures can be resilient not only because of their mechanical durability but also in terms of their hygienic suitability, for example by cleaning with alkalis, acids or oxidizing agents.

A plastic can be used for the 3D printing. When choosing the plastic used for the 3D printing, care can be taken to ensure that the molding and/or drying modules produced with and from it can achieve a predetermined strength and/or temperature resistance.

The molding and/or drying module can be produced by means of 3D printing in such a way that the molding and/or drying module can have a contact pressure resistance of 0.01 bar to 10 bar, or up to 40 bar. To be able to achieve this contact pressure resistance, a wall thickness distribution of the molding and/or drying module and/or a porosity of the molding and/or drying module can be taken into account for the material used for the 3D printing.

The molding and/or drying module can be produced by means of 3D printing in such a way that the molding and/or drying module can have a temperature resistance of at least 200° C. or at least 300° C. To be able to achieve this temperature resistance, a wall thickness distribution of the molding and/or drying module and/or a porosity of the molding and/or drying module can be taken into account for the material used for the 3D printing.

The molding and/or drying module can be produced by means of 3D printing in such a way that the molding and/or drying module can have pores with a pore size of 0.1 μm to 1 mm, for example of 0.3 mm to 0.7 mm. The limit values of these value ranges can be included. As a result of the pores, excess water can drain from a fiber-containing pulp which was introduced into the molding and/or drying module to produce a container comprising fibers.

The method can further comprise reworking an inner surface of the molding and/or drying module to smooth the inner surface. For example, the reworking can comprise grinding, brushing, honing, pickling or e-polishing. As a result, a container comprising fibers produced in the molding and/or drying module can have a correspondingly smoother surface and/or can be released more easily from the molding and/or drying module after being produced therein. The reworking can comprise one or more points from the following list:
machining with geometrically defined cutting (e.g. turning, drilling, milling),
machining with geometrically undefined cutting (e.g. grinding, honing, lapping),
thermal methods (e.g. spark erosion, wire erosion, sinker EDM),
laser beam machining (laser cutting, laser drilling),
and chemical methods (hirtization, thermal deburring).

The molding and/or drying module can comprise two associated half-shells. The two half-shells can be associated shell parts of the molding and/or drying module.

The two half-shells can be connected to one another by means of a closure mechanism. Alternatively or additionally, the two half-shells can comprise eyelets on their outer surfaces which can be provided for a screw connection of the half-shells.

The molding and/or drying module can be produced by means of 3D printing in such a way that the molding and/or drying module can comprise more than two associated shell parts. Three to five or more associated shell parts can be provided. For example, the more than two associated shell parts can comprise a shell part for a base, one or more shell parts for a collar, one or more shell parts for a neck and/or one or more shell parts for a threaded region. The one or more shell parts for the threaded region can be advantageously characterized by a suitable pore design and/or pressure loss control for moisture removal from introduced fiber-containing pulp. For example, the shell part can be designed in the shape of a cup for the base. The cup-shaped design can form a support for the support structure and/or serve as a holder during a change.

The more than two shell parts can be connected to one another by means of a closure mechanism. Alternatively or additionally, the shell parts can comprise eyelets on their outer surfaces which can be provided for a screw connection of corresponding associated shell parts.

A shell part can consist of one part or comprise a plurality of parts which can be assembled. The plurality of parts can be connected to one another by means of a joining method, for example by means of welding. Welded seams can then be provided as a connection between the plurality of individual parts.

The molding module can be designed such that it can be inserted into a housing. The housing can enclose an outer region of the molding module. The molding module can thereby be sealed to the outside which allows excess water to drain from a fiber-containing pulp which was introduced into the molding module. For the pulp to be deposited into the molding module, the latter can be arranged embedded in the housing for example upside down on a feed device for the fiber-containing pulp.

The production of the molding and/or drying module can comprise providing a porous wall or a plurality of porous walls of the molding and/or drying module. When there is a plurality of walls, adjacent walls can be connected to one another in each case. One of the walls can enclose a cavity of the molding and/or drying module, wherein an inner surface of this wall can come into contact with an outer surface of the container when the container comprising fibers is produced.

The provision can take place such that a porous wall adjoining a cavity of the molding and/or drying module can comprise an inner surface with a porosity with a pore size of 0.1 μm to 50 μm, or with a pore size of 0.1 μm to 500 μm. The range limits can be included. For example, provision can take place such that this porous wall can have a thickness of 1 μm to 100 μm, or a thickness of 100 μm to 50 mm. The range limits can be included. The pore size can enable a smooth outer surface of a fiber-comprising container to be produced, and thereby also allow water and/or water vapor to be transported away from the fiber-comprising container to be produced.

The provision can take place such that an additional porous wall can surround the porous wall adjoining the cavity of the molding and/or drying module. The additional porous wall can surround the porous wall only on an outer side of the porous wall so that the inner surface of the porous wall can remain free. The additional porous wall can have a support function for the porous wall.

The provision can take place such that channels for heating media and channels for removing water and/or water vapor can be provided in the additional porous wall. For example, the provision can take place such that additional channels for heating media and additional channels for removing water and/or water vapor can be provided in the porous wall adjoining the cavity of the molding and/or drying module. For example, the provision can take place such that openings in the additional channels for heating media and openings in the additional channels for removing water and/or water vapor can be provided in the inner surface. For example, the provision can take place such that the channels for heating media and the additional channels for heating media and the channels for removing water and/or water vapor and the additional channels for removing water and/or water vapor can each be connected to one another.

The provision can take place such that the channels for heating media and/or the channels for removing water and/or water vapor can be manufactured directly in the additional porous wall by means of the additive manufacturing method. For example, the provision can take place such that the additional channels for heating media and/or the additional channels for removing water and/or water vapor can be manufactured directly in the porous wall by means of the additive manufacturing method.

The provision can take place such that the channels for heating media and/or the channels for removing water and/or water vapor and/or the additional channels for heating media and/or the additional channels for removing water and/or water vapor can have a round, oval or angular cross-sectional area.

For example, the provision can take place such that the channels for heating media and/or the channels for removing water and/or water vapor and/or the additional channels for heating media and/or the additional channels for removing water and/or water vapor can run in parallel with or perpendicularly to or at an angle to a longitudinal axis of the molding and/or drying module. For example, the provision can take place such that a distance between the channels for heating media and/or the channels for removing water and/or water vapor and/or the additional channels for heating media and/or the additional channels for removing water and/or water vapor can be 0.01 mm to 100 mm. This means a distance between adjacent channels. A distance of the above-mentioned channels to a surface of the molding and/or drying modules can be 0.01 mm to 100 mm. The range limits can each be included.

The provision can take place such that the channels for heating media can be provided in a first wall layer of the additional porous wall, and the channels for removing water and/or water vapor can be provided in a second wall layer of the additional porous wall. For example, the provision can take place such that the additional channels for heating media can be provided in a third wall layer of the porous wall, and the additional channels for removing water and/or water vapor can be provided in a fourth wall layer of the porous wall.

Furthermore, a device is provided for carrying out the method, as described above or further below. The device can include a 3D printer, a supply of material used for 3D printing and data instructions which describe the molding and/or drying module to be produced.

In addition, a molding and/or drying module is produced by means of the method as described above or further below.

To produce the molding and/or drying module, the device can have been used for carrying out the method, as described above or further below.

Furthermore, a method for producing a container comprising fibers is provided using a molding and/or drying module which was produced by means of the method, as described above or further below.

A fiber-containing pulp can be introduced into the molding and/or drying module, which pulp can be pressed, for example, by inflating an elastic balloon in the interior of the molding and/or drying module, whereby the container comprising fibers can be molded. Drying the container comprising fibers following molding can be provided.

The method for producing a container comprising fibers using a molding and/or drying module can also comprise introducing fiber-containing pulp into the molding and/or drying module, wherein, for example, the molding and/or drying module can be arranged upside down on a feed device for the fiber-containing pulp, exerting pressure for molding the container comprising fibers, drying the molded container comprising fibers, and for example forming a counter-pressure pulse for releasing the container comprising fibers from the molding and/or drying module. These method steps can take place when a single molding and/or drying module is used in which a container comprising fibers can first be molded, and then (in the same module) the previously molded container comprising fibers can be dried.

Alternatively, the method for producing a container comprising fibers using a molding and/or drying module can also comprise: introducing fiber-containing pulp into the molding module, wherein, for example, the molding module is arranged upside down on a feed device for the fiber-containing pulp, exerting pressure to mold the container comprising fibers, for example forming a counter-pressure pulse to release the molded container comprising fibers from the molding module, removing the molded container comprising fibers from the molding module, introducing the molded container comprising fibers into the drying module, drying the molded container comprising fibers, and, for example, forming a counter-pressure pulse to release the container comprising fibers from the molding and/or drying module. These method steps can take place when a molding module is used for molding a container comprising fibers and a drying module is used for drying the molded container comprising fibers. There can be two modules.

Furthermore, the method can comprise introducing heating medium into the channels for heating media. For example, the method can additionally comprise introducing heating medium into the additional channels for heating media (if these additional channels are provided).

In addition, the method can comprise removing water and/or water vapor from the channels for removing water and/or water vapor. For example, the method can additionally comprise removing water and/or water vapor from the additional channels for removing water and/or water vapor (if these additional channels are provided).

In addition, a device for producing containers comprising fibers is provided using fiber-containing pulp, wherein the device comprises one or more molding and/or drying modules, as described further above or further below.

### BRIEF DESCRIPTION OF FIGURES

The accompanying figures show, by way of example, aspects and/or exemplary embodiments of the disclosure for better understanding and illustration. In the figures:

FIG. 1 shows two half-shells produced by means of 3D printing,

FIG. 2 shows the two assembled half-shells,

FIG. 3 shows a sectional illustration of the half-shells arranged in a housing,

FIG. 4A shows a schematic longitudinal section through a molding and/or drying module,

FIG. 4B shows a first embodiment of channels for heating media and channels for removing water and/or water vapor from the molding and/or drying module,

FIG. 4C shows a second embodiment of channels for heating media and channels for removing water and/or water vapor from the molding and/or drying module,

FIG. 5A shows the second embodiment of channels for heating media,

FIG. 5B shows the first embodiment of channels for heating media, and

FIG. 5C shows a third embodiment of channels for heating media.

### DETAILED DESCRIPTION OF FIGURES

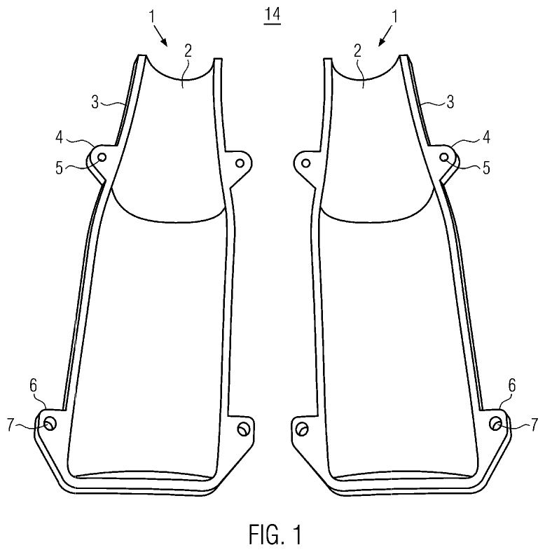

FIG. 1 shows two half-shells 1 of a molding and/or drying module 14, which were produced by means of 3D printing. The two half-shells 1 are formed identically in the illustration. An inner surface 2 of the half-shell 1 can serve for the deposition of fiber-containing pulp. To be able to easily and reliably release the pulp pressed in the production process of a container comprising fibers (for example by means of an inflatable balloon) from the inner surface 2, the inner surface 2 can be reworked after production by means of 3D printing. The reworking can comprise grinding, brushing or honing. In detail, the reworking can comprise one or more points from the following list:
machining with geometrically defined cutting (e.g. turning, drilling, milling),
machining with geometrically undefined cutting (e.g. grinding, honing, lapping),
thermal methods (e.g. spark erosion, wire erosion, sinker EDM),
laser beam machining (laser cutting, laser drilling),
and chemical methods (hirtization, thermal deburring).

The half-shell 1 can comprise pores, wherein, for example, the pores can have a pore size of 0.1 μm to 1 mm, for example 0.3 mm to 0.7 mm, so that water pressed out of a fiber-containing pulp can leave the half-shell in the direction of an outer surface 3. The pores can arise during production by means of 3D printing. The limit values of the specified value ranges can be included.

In a shoulder region, the outer surface 3 comprises two first holding devices 4, each having a continuous bore 5 into which screws for mechanically connecting the two half-shells 1 shown can be introduced. In addition, the outer surface 3 in a body region comprises two first holding devices 6, each having a continuous bore 7 into which screws for mechanically connecting the two shown half-shells 1 can be introduced.

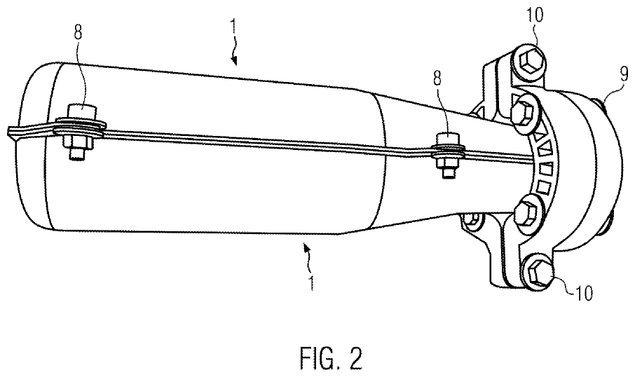

FIG. 2 shows the two assembled half-shells 1 from FIG. 1. The mechanical connection of the two half-shells 1 was achieved here by introducing screws 8 into the continuous bores 5, 7. In the mouth region, the two half-shells 1 are surrounded by a clamp 9 screwed by means of screws 10. Instead of providing a mechanical connection using screws, a closure mechanism can also be used to assemble the two half-shells; the holding devices 4, 6 with the continuous bores 5, 7 in the outer surface are then not required.

The two assembled half-shells 1 can be used in a method for producing a container comprising fibers. For this purpose, fiber-containing pulp can be introduced into the interior of the half-shells so that the pulp can deposit on the inner surface 2 of the half-shells 1. An elastic balloon can be introduced into the assembled half-shells 1 and inflated with compressed air. As a result, the elastic balloon can exert pressure on the deposited pulp and at least partially compress it. In this case, at least a portion of the water contained in the pulp can escape. By exerting the pressure on the pulp, the container comprising fibers can be molded in the assembled half-shells 1. In order to release the molded containers comprising fibers from the half-shells 1 or detach them from the inner surface 2 of the half-shells, a counter-pressure pulse can be formed. For this purpose, the screws 8 and the clamp 9 can be loosened so that the two half-shells 1 can be separated from one another at least partially. The counter-pressure pulse can be oriented from outside the assembled half-shells 1 into the interior of the half-shells 1.

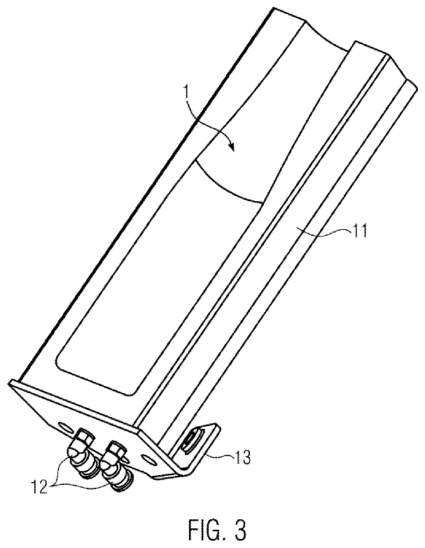

FIG. 3 shows a sectional illustration of the half-shells 1 arranged in a housing 11. The housing 11 can enclose an outer region of the half-shells 1 and therefore the molding and/or drying module 14. The half-shells 1 or the molding and/or drying module 14 can thereby be sealed to the outside, whereby excess water can drain from a fiber-containing pulp which was introduced into the half-shells 1 or the molding and/or drying module 14.

The housing 11 in this case comprises, for example, two water outlets 12 via which the excess water, which can be pressed out, for example, during pressing of the fiber-containing pulp by means of an inflatable elastic balloon, can be discharged. For example, a water outlet or more than two water outlets can be included in the housing.

In addition, the housing 11 comprises a holder 13. The holder 13 can be provided for arranging the housing 11 with the half-shells therein in a device for producing containers comprising fibers using fiber-containing pulp.

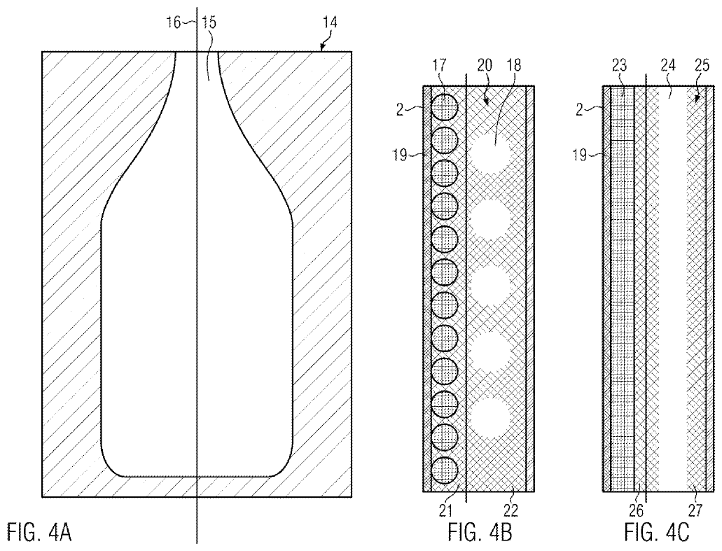

FIG. 4A shows a schematic longitudinal section along a longitudinal axis 16 through a molding and/or drying module 14 with a cavity 15 for receiving a fiber-containing pulp for producing a container comprising fibers. The molding and/or drying module 14 can comprise a porous wall or a plurality of porous walls in which channels for heating media and channels for removing water and/or water vapor can be provided.

FIG. 4B shows a first embodiment of channels 17 for heating media, and channels 18 for removing water and/or water vapor from the molding and/or drying module 14. Two walls 19, 20 are shown here. The porous wall 19 adjoining the cavity 15 of the molding and/or drying module 14 comprises an inner surface 2. The inner surface 2 can comprise a porosity with a pore size of 0.1 μm to 500 μm, wherein, for example, this porous wall 19 can have a thickness of 1 μm to 50 mm. Another porous wall 20 surrounds the porous wall 19 adjoining the cavity 15 of the molding and/or drying module 14. The aforementioned channels 17 for heating media and channels 18 for removing water and/or water vapor are provided in the additional porous wall 20.

In the illustrated first embodiment, the channels 17 for heating media and the channels 18 for removing water and/or water vapor each run perpendicularly to the longitudinal axis 16 of the molding and/or drying module 14.

The channels 17 for heating media are provided in a first wall layer 21 of the additional porous wall 20, and the channels 18 for removing water and/or water vapor are provided in a second wall layer 22 of the additional porous wall 20. The water and/or water vapor in the channels 18 can be removed by vacuum. The vacuum can have an absolute residual pressure of 500 mbar to 300 mbar, or 300 mbar to 150 mbar. The range limits can be included.

FIG. 4C shows a second embodiment of channels 23 for heating media and channels 24 for removing water and/or water vapor of the molding and/or drying module 14. Two walls 19, 25 are shown here. The porous wall 19 adjoining the cavity 15 of the molding and/or drying module 14 comprises the inner surface 2. An additional porous wall 25 surrounds the porous wall 19 adjoining the cavity 15 of the molding and/or drying module 14. The previously mentioned channels 23 for heating media and channels 24 for removing water and/or water vapor are provided in the additional porous wall 25.

In the illustrated second embodiment, the channels 23 for heating media and the channels 24 for removing water and/or water vapor each run in parallel with the longitudinal axis 16 of the molding and/or drying module 14.

The channels 23 for heating media are provided in a first wall layer 26 of the additional porous wall 25, and the channels 24 for removing water and/or water vapor are provided in a second wall layer 27 of the additional porous wall 25.

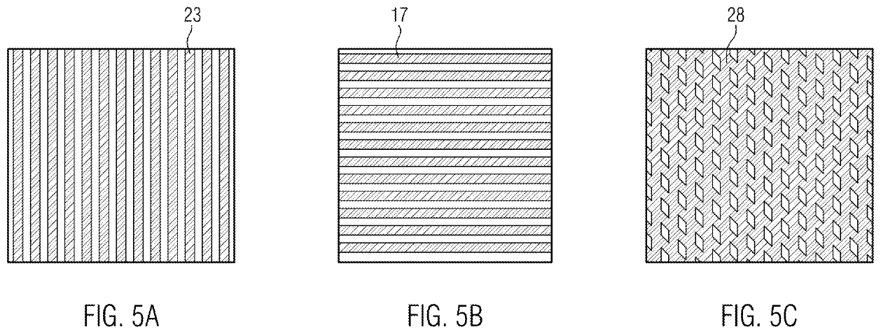

FIG. 5A shows the second embodiment of channels 23 for heating media which run in parallel with the longitudinal axis 16 of the molding and/or drying module 14.

FIG. 5B shows the first embodiment of channels 17 for heating media which run perpendicularly to the longitudinal axis 16 of the molding and/or drying module 14.

FIG. 5C shows a third embodiment of channels 28 for heating media which are grid-like and run at different angles to the longitudinal axis 16 of the molding and/or drying module 14.

1. A method for producing molding and/or drying modules for producing containers comprising fibers by means of the molding and/or drying modules, wherein the method comprises:
producing a molding and/or drying module, wherein at least part of the molding and/or drying module is produced by means of an additive manufacturing method.

2. The method according to claim 1, wherein the additive manufacturing method is 3D printing, wherein a metal or metal mixture is used for the 3D printing, or wherein a plastic is used for the 3D printing.

3. The method according to claim 2, wherein the molding and/or drying module is produced by means of 3D printing in such a way that the molding and/or drying module has a contact pressure resistance of 0.01 bar to 10 bar or up to 40 bar, and/or
wherein the molding and/or drying module is produced by means of 3D printing in such a way that the molding and/or drying module has a temperature resistance of at least 200° C. or at least 300° C., and/or
wherein the molding and/or drying module is produced by means of 3D printing in such a way that the molding and/or drying module has pores with a pore size of 0.1 μm to 1 mm.

4. The method according to claim 1, also comprising reworking an inner surface of the molding and/or drying module for smoothing the inner surface, wherein, the reworking comprises grinding, brushing, honing, pickling or e-polishing, wherein, the reworking comprises machining with geometrically defined cutting, machining with geometrically undefined cutting, one or more thermal methods, laser beam machining and/or one or more chemical methods.

5. The method according to claim 1, wherein the molding and/or drying module comprises two associated half-shells, or wherein the molding and/or drying module is produced by means of 3D printing in such a way that the molding and/or drying module comprises more than two associated shell parts, wherein, the more than two associated shells comprise a shell part for a base, one or more shell parts for a collar, one or more shell parts for a neck and/or one or more shell parts for a threaded region, wherein, the shell part for the base is designed in the shape of a cup.

6. The method according to claim 4, wherein the molding module is designed such that it can be inserted into a housing.

7. The method according to claim 6, wherein the production of the molding and/or drying module comprises providing a porous wall or a plurality of porous walls of the molding and/or drying module.

8. The method according to claim 7, wherein the provision takes place such that a porous wall adjoining a cavity of the molding and/or drying module comprises an inner surface with a porosity with a pore size of 0.1 μm to 50 μm or with a pore size of 0.1 μm to 500 μm.

9. The method according to claim 7, wherein the provision takes place such that an additional porous wall surrounds the porous wall adjoining the cavity of the molding and/or drying module.

10. A device for carrying out the method according to claim 1.

11. A method for producing a container comprising fibers using a molding and/or drying module which has been produced by means of the method according to claim 9.

12. The method according to claim 12, wherein the method also comprises:
introducing fiber-containing pulp into the molding and/or drying module, wherein, the molding and/or drying module is arranged upside down on a feed device for the fiber-containing pulp,
exerting a pressure to mold the container comprising fibers,
drying the molded container comprising fibers,
forming a counter-pressure pulse for releasing the container comprising fibers from the molding and/or drying module
or
introducing fiber-containing pulp into the molding module, wherein, the molding module is arranged upside down on a feed device for the fiber-containing pulp,
exerting a pressure to mold the container comprising fibers,
forming a counter-pressure pulse for releasing the molded container comprising fibers from the molding module,
removing the molded container comprising fibers from the molding module,
introducing the molded container comprising fibers into the drying module,
drying the molded container comprising fibers,
forming a counter-pressure pulse for releasing the container comprising fibers from the molding and/or drying module.

13. The method according to claim 12, wherein the method also comprises:
introducing heating medium into the channels for heating media channels, introducing heating medium into the additional channels for heating media,
removing water and/or water vapor from the channels for removing water and/or water vapor, removing water and/or water vapor from the additional channels for removing water and/or water vapor.

14. The method according to claim 9, wherein, the provision takes place such that channels for heating media and channels for removing water and/or water vapor are provided in the additional porous wall.

15. The method according to claim 9, wherein, in the porous wall adjoining the cavity of the molding and/or drying module, additional channels for heating media and additional channels for removing water and/or water vapor are provided, wherein, openings in the additional channels for heating media and openings in the additional channels for removing water and/or water vapor are provided in the inner surface, wherein, the channels for heating media and the additional channels for heating media and the channels for removing water and/or water vapor and the additional channels for removing water and/or water vapor are each connected to one another.

16. The method according to claim 9, wherein, the provision takes place such that the channels for heating media and/or the channels for removing water and/or water vapor are manufactured directly in the additional porous wall by means of the additive manufacturing method, and that, the additional channels for heating media and/or the additional channels for removing water and/or water vapor are manufactured directly in the porous wall by means of the additive manufacturing method.

17. The method according to claim 9, wherein, the provision takes place such that the channels for heating media and/or the channels for removing water and/or water vapor and/or the additional channels for heating media and/or the additional channels for removing water and/or water vapor have a round, oval or angular cross-sectional area, and that, the channels for heating media and/or the channels for removing water and/or water vapor and/or the additional channels for heating media and/or the additional channels for removing water and/or water vapor run in parallel with or perpendicularly to or at an angle to a longitudinal axis of the molding and/or drying module, and that a distance between the channels for heating media and/or the channels for removing water and/or water vapor and/or the additional channels for heating media and/or the additional channels for removing water and/or water vapor is 1 mm to 5 mm.

18. The method according to claim 9, wherein, the provision takes place such that the channels for heating media are provided in a first wall layer of the additional porous wall, and the channels for removing water and/or water vapor are provided in a second wall layer of the additional porous wall, and that, the additional channels for heating media are provided in a third wall layer of the porous wall, and the additional channels for removing water and/or water vapor are provided in a fourth wall layer of the porous wall.
